(19) United States
(12) Patent Application Publication
(10) Pub. No.: US 2008/0211388 A1
(43) Pub. Date: Sep. 4, 2008

(54) LIGHT EMITTING SEMICONDUCTOR DEVICE

(75) Inventor: Katsuyuki OKIMURA, Tokyo (JP)

Correspondence Address: YOUNG & THOMPSON, 209 Madison Street, Suite 500, ALEXANDRIA, VA, 22314, US

(73) Assignee: NEC LIGHTING, LTD., Tokyo (JP)

(21) Appl. No.: 12/018,220

(22) Filed: Jan. 23, 2008

(30) Foreign Application Priority Data
Feb. 20, 2007 (JP) 2007-039228

(51) Int. Cl. H01J 1/62

(52) U.S. Cl. 313/503

(57) ABSTRACT

A light emitting semiconductor device includes: a package; a light emitting device; a reflection member; and a light transmissive fluorescent material layer. The package has a bowl-like recess, and the light emitting device is placed at the center of the recess. The reflection member is provided on an inclined surface of the package surrounding the light emitting device and has a fluorescent material layer. The light transmissive fluorescent material layer is provided to face the light emitting device inside the inclined surface.

This application is based upon and claims the benefit of priority from Japanese patent application No. 2007-039228, filed on Feb. 20, 2007, the disclosure of which is incorporated herein in its entirety by reference.

### BACKGROUND OF THE INVENTION

1. Field of the Invention

The present invention relates to a light emitting semiconductor device, and more particularly to a light emitting semiconductor device that can emit white light using a blue light emitting diode (LED) and a fluorescent material that emits yellow light in combination.

2. Description of the Related Art

A white light source has been used in which a blue light emitting device is sealed by transparent resin containing a fluorescent material. The white light source emits white light by combining blue light emitted from the blue light emitting device and yellow light emitted from the fluorescent material that the blue light enters. With the white light source has such a structure, the blue light emitting device and the fluorescent material feature high light absorption and the emission efficiency of white light is low. This is because a considerable part of the light emitted from the blue light emitting device is reflected by the fluorescent material and returned to the blue light emitting device. In the blue light emitting device, the light is only slightly again emitted outward because of a high refractive index, and most of the light is absorbed in the blue light emitting device. On the other hand, a considerable part of the light entering a fluorescent material layer is absorbed in the fluorescent material layer, and thus the emission efficiency of the white light emitted outward through the fluorescent material layer is low.

Most of currently used semiconductor devices that emit white light adopt the method of obtaining white light by a combination of a blue LED and a fluorescent material that emits yellow light.

Methods for combining a light emitting device and fluorescent material include:
1) a method of directly applying fluorescent material to a surface of a diced light emitting device;
2) a method of covering a die-bonded light emitting device with resin containing a dispersed fluorescent material; and
3) a method of placing a sheet containing a dispersed fluorescent material at a position separated from a light emitting device.

Japanese Patent Laid-Open No. 2003-124521 discloses a semiconductor light emitter in which a reflection case is provided to surround an LED chip on a substrate, a space surrounding the LED chip in the reflection case is filled with light transmissive resin, and the reflection case and the light transmissive resin contain a fluorescent agent.

Japanese Patent Laid-Open No. 2003-298117 discloses a light emitting diode in which a reflection member that constitutes a side wall formed with a reflection surface having high reflectivity is secured to an outer periphery of a substrate, an inner side surface of the side wall is the reflection surface having high reflectivity, light transmissive epoxy resin is sealed in a space surrounded by the side wall, a facing reflection mirror having a reflection surface to which fluorescent material-containing resin is applied is placed at the center of the light transmissive epoxy resin facing a light emitting surface of a light emitting device.

Japanese Patent Laid-Open No. 2006-49814 discloses a light emitter in which a first reflection member that forms a reflection surface is provided so as to surround a light emitting device on a substrate, a second reflection member is provided so as to surround the first reflection member on the substrate, and a wavelength conversion layer is provided above the light emitting device.

Next, problems of the related art will be described.

Generally, light emitting devices have differences in light intensity depending on the emitting directions. FIGS. 1A and 1B schematically show differences in light intensity in light emitting areas in a light emitting semiconductor device. FIG. 1A is a top view of the light emitting semiconductor device, and FIG. 1B is a side view thereof.

Light emitting semiconductor device 1 includes package 2 having a truncated conical recessed surface, light emitting device 3 placed at the center of package 2, and transmissive fluorescent material layer 5 provided on an opening of package 2, and an unshown conductor or conductor wire is connected to light emitting device 3.

In light emitting semiconductor device 1, light emitting device 3 emits light with high intensity forward at the center of light emitting semiconductor device 1 as shown in FIG. 1B. For such light emitting device 3, blue light from light emitting device 3 passes, as it is, through transmissive fluorescent material layer 5 to become substantially blue in high intensity light emitting area 11, while the blue light becomes white, that is a desired color, in low intensity light emitting area 12. Thus, light emitting semiconductor device 1 has different colors at the center and at its surrounding areas to cause color unevenness.

The devices disclosed in Japanese Patent Laid-Open No. 2003-124521, Japanese Patent Laid-Open No. 2003-298117, and Japanese Patent Laid-Open No. 2006-49814 have a structure similar to that in FIGS. 1A and 1B, but include no description on a method for solving such color unevenness.

### SUMMARY OF THE INVENTION

The present invention has an object to provide a light emitting semiconductor device that can prevent color unevenness caused by the directional properties of differences in intensity of light emitted from a light emitting device, with a simple structure.

A light emitting semiconductor device according to an aspect of the present invention includes: a package; a light emitting device; a reflection member; and a light transmissive fluorescent material layer. The package has a bowl-like recess, and the light emitting device is placed at the center of the recess. The reflection member is provided on an inclined surface of the package surrounding the light emitting device and has a fluorescent material layer. The light transmissive fluorescent material layer is provided correspondingly to a high intensity light emitting area of the light emitting device inside the inclined surface.

The above and other objects, features and advantages of the present invention will become apparent from the following description with reference to the accompanying drawings which illustrate examples of the present invention.

### BRIEF DESCRIPTION OF THE DRAWINGS

FIG. 1A is a schematic top view showing differences in light intensity in light emitting areas in a light emitting semiconductor device;

FIG. 1B is a schematic side view showing differences in light intensity in the light emitting areas in the light emitting semiconductor device;

FIG. 2 is a schematic sectional view of a light emitting semiconductor device according to an exemplary embodiment of the present invention; and

FIG. 3 is a schematic perspective view of the light emitting semiconductor device according to the exemplary embodiment of the present invention.

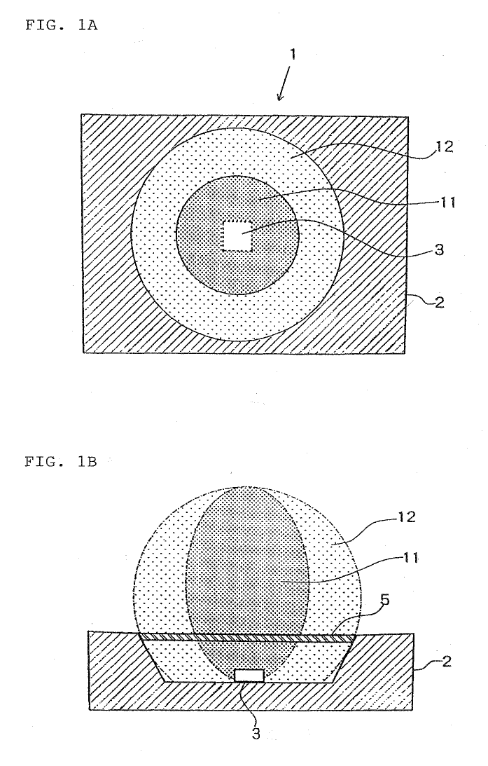

### DESCRIPTION OF THE EXEMPLARY EMBODIMENT

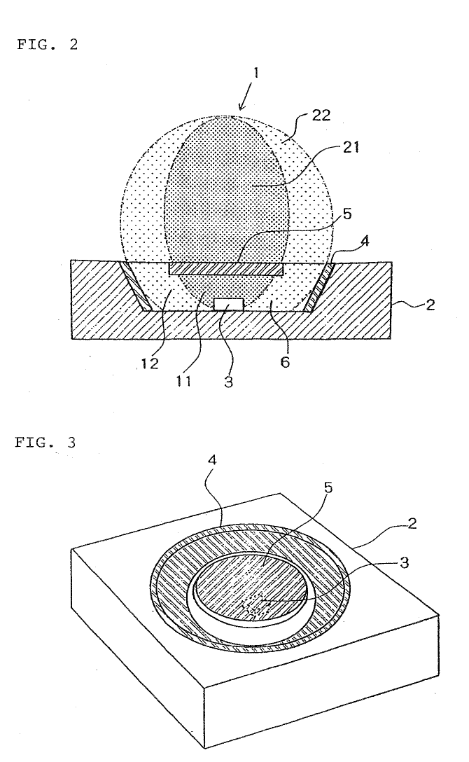

In FIGS. 2 and 3, reference numeral 1 denotes a light emitting semiconductor device, reference numeral 2 denotes a package, reference numeral 3 denotes a light emitting device, reference numeral 4 denotes a side reflection fluorescent material layer, reference numeral 5 denotes a top transmissive fluorescent material layer, reference numeral 6 denotes a light transmissive material, reference numeral 11 denotes a high intensity light emitting area, reference numeral 12 denotes a low intensity light emitting area, reference numeral 21 denotes a first light emitting area, and reference numeral 22 denotes a second light emitting area.

A method for applying excitation light to a fluorescent material and obtaining visible light by wavelength conversion includes a method of providing a fluorescent material layer between an excitation source and an observer for “transmission”, and a method of causing fluorescent material layers of an excitation source and an observer to face each other for “reflection”.

For the “transmission”, when excitation light emitted from a light emitting device passes through the fluorescent material layer, the light partly passes through gaps between fluorescent material particles while repeating reflection, and partly passes through the fluorescent material particles. The light repeats reflection and is attenuated, and is also attenuated in transmission. Thus, high attenuation occurs in wavelength conversion of the excitation light by the fluorescent material in transmission.

On the other hand, for the “reflection”, the light does not repeat reflection or does not pass through the fluorescent material layer, thereby allowing efficient wavelength conversion.

In the present invention, a difference in efficiency between the “transmission” and the “reflection” is used. Light emitting intensity distribution during passage of the excitation light through the fluorescent material layer is divided into two parts, the “transmission” is used in high intensity light emitting area 11, and the “reflection” is used in low intensity light emitting area 12, thereby reducing color unevenness in question.

With reference to FIGS. 2 and 3, light emitting device 3 is placed at the center of the bottom surface of package 2 having a bowl-like (truncated conical) recessed surface. Package 2 is herein integrally formed. In the present invention, however, a side wall that forms a truncated conical space may be joined onto a substrate on which light emitting device 3 is mounted at the center. The truncated conical space may be replaced by a truncated pyramidal space to form a rectangular emission opening.

Light emitting device 3 is herein a blue light emitting device, and generally a blue light emitting diode. To light emitting device 3, an invisible lead that supplies electric power is connected.

Light transmissive material 6 is sealed in the truncated conical space in package 2. Generally, transparent epoxy resin is used as light transmissive material 6. Light transmissive material 6 may be omitted if top transmissive fluorescent material layer 5 can be held at a position facing light emitting device 3.

Transmissive fluorescent material layer 5 is formed on a top surface of light transmissive material 6 facing light emitting device 3 in high intensity light emitting area 11. Generally used transmissive fluorescent material layer 5 is a transparent material containing a yellow coloring fluorescent material and heat-cured to be formed into a sheet shape. Alternatively, transmissive fluorescent material layer 5 may be formed of the top surface of light transmissive material 6 containing a yellow coloring fluorescent material. Transmissive fluorescent material layer 5 absorbs visible light or ultraviolet light having an emission wavelength and emitted from light emitting device 3, repeats reflection therein, and then converts the light into light of a desired color (white in this example) and emits the light outward.

On the other hand, reflection fluorescent material layer 4 is placed on the truncated conical recessed surface of package 2 and this fluorescent material is a transparent material containing a yellow coloring fluorescent material for reflecting light from light emitting device 3. Reflection fluorescent material layer 4 converts visible light or ultraviolet light having an emission wavelength of low intensity light emitting area 12 and the light is emitted from light emitting device 3 into light of a desired color (white in this example) and reflects the light. The converted light passes through light transmissive material 6 outside transmissive fluorescent material layer 5 and is emitted outward, and most of light having entered transmissive fluorescent material layer 5 is also emitted outward while being reflected therein.

Thus, light of first light emitting area 21 converted from high intensity light emitting area 11 repeats reflection in transmissive fluorescent material layer 5 and is thus attenuated and emitted. Thus, high attenuation occurs in the wavelength conversion of the excitation light by the fluorescent material, and blue light from light emitting device 3 does not pass, as it is, through transmissive fluorescent material layer 5 to become substantially blue but is emitted as white light, which is desired. Further, light of second light emitting area 22 converted from low intensity light emitting area 12 does not repeat reflection or does not pass through the fluorescent material layer, and is thus efficiently subjected to wavelength conversion and emitted as white light, which is desired.

Adjusting a thickness of the fluorescent material layer or a blend ratio of the fluorescent material allows a balance between first light emitting area 21 using transmissive fluorescent material layer 5 and second light emitting area 22 using reflection fluorescent material layer 4, thereby achieving light emitting semiconductor device 1 without having color unevenness.

In the exemplary embodiment, the combination of the blue light emitting diode and the yellow coloring fluorescent material is used to obtain white light as described above, but is not limited to this combination, any combination of a light emitter and a color light emitting fluorescent material that can obtain white light may be used.

The combination of a light emitter and a color light emitting fluorescent material that can obtain white light includes a combination of a light emitting diode and a plurality of fluorescent materials such as a combination of a blue light emitting diode and yellow and red color light emitting fluorescent materials, a combination of a blue light emitting diode and green and orange color light emitting fluorescent materials, a combination of a near ultraviolet light emitting diode and blue, green and red color light emitting fluorescent materials, or a combination of a near ultraviolet light emitting diode and blue, green and orange color light emitting fluorescent materials.

As another aspect of a light emitting semiconductor device of the present invention, a light transmissive member that seals the light emitting device may be provided inside the inclined surface of the reflection member. The fluorescent material layer and the light transmissive fluorescent material layer may contain a fluorescent material that absorbs part or all of color light emitted from the light emitting device and emits color light having a different wavelength from the above described color light.

As described above with reference to the exemplary embodiment, the present invention uses the light transmissive fluorescent material layer that has high attenuation in the high intensity light emitting area of the light emitting device, and uses the reflection fluorescent material layer that has low attenuation in the low intensity light emitting area, thereby allowing the emission of wavelength converted light without color unevenness. Also, the fluorescent material used as the light emitting device can be efficiently used to increase light output.

While preferred embodiments of the present invention have been described using specific terms, such description is for illustrative purposes only, and it is to be understood that changes and variations may be made without departing from the spirit or scope of the following claims.

What is claimed is:

1. A light emitting semiconductor device comprising:
a package having a bowl-like recess;
a light emitting device placed at the center of said recess;
a reflection member provided on an inclined surface of said package that surrounds said light emitting device, having a fluorescent material layer; and
a light transmissive fluorescent material layer provided to face said light emitting device inside said inclined surface.

2. The light emitting semiconductor device according to claim 1, further comprising a light transmissive member that is provided inside said inclined surface and that seals said light emitting device.

3. The light emitting semiconductor device according to claim 1, wherein said fluorescent material layer and said light transmissive fluorescent material layer contain a fluorescent material that absorbs part or all of color light emitted from said light emitting device and emits color light having a different wavelength from said color light.

4. The light emitting semiconductor device according to claim 3, wherein said light emitting device is a blue light emitting device, said fluorescent material is a fluorescent material that emits yellow light, and said light emitting semiconductor device emits white light.

5. The light emitting semiconductor device according to claim 4, wherein said blue light emitting device is a blue light emitting diode.
